(19) United States
(12) Patent Application Publication
(10) Pub. No.: US 2025/0393105 A1
(43) Pub. Date: Dec. 25, 2025

(54) ANODE FOR DIRECT CURRENT ELECTRIC ARC FURNACE

(71) Applicant: HarbisonWalker International Holdings, Inc., Moon Township, PA (US)

(72) Inventors: Aaron Michael POTTER, Ironton, OH (US); Lee NOSBISCH, Chester, VA (US)

(73) Assignee: HarbisonWalker International Holdings, Inc., Moon Township, PA (US)

(21) Appl. No.: 18/751,886

(22) Filed: Jun. 24, 2024

(51) Int. Cl. H05B 7/08; C04B 35/74

(52) U.S. Cl. CPC H05B 7/08; C04B 35/74; C04B 2235/3206; C04B 2235/321; C04B 2235/3217; C04B 2235/9669

(57) ABSTRACT

An anode for a direct current electric arc furnace includes dry vibratable monolithic refractory material positioned on a bottom wall of the furnace, a plurality of steel pins extending upward from the bottom wall of the furnace and through the dry vibratable monolithic refractory material, and an anode cap positioned on top of the dry vibratable monolithic refractory material. The steel pins are surrounded by the dry vibratable monolithic refractory material. The anode cap includes a plurality of pin holes formed therein with which the steel pins correspond and through which the steel pins extend.

### FIELD OF THE INVENTION

The present invention relates generally to direct current electric arc furnaces, and, more specifically, to an anode for a direct current electric arc furnace that is designed to have an extended life span.

### BACKGROUND OF THE INVENTION

Direct current electric arc furnaces are generally utilized to melt materials having high melting points. Typically, a direct current anode is positioned on the bottom of the furnace to be in direct contact with materials charged to the furnace for melting. The charged materials are usually a combination of steel scrap with other sources of iron units. The anode is surrounded by refractory brick to protect the sides of the anode from the charged material when it becomes molten.

A cathode is positioned above and in a proximity to the anode, thereby creating an arc between the anode and the cathode that melts the charged material. The cathode is typically a single graphite electrode. The arc is generated between the graphite top electrode and the anode bottom electrode of the furnace. The arc between the anode and cathode produces severe temperatures in the furnace and results in severe wear of the refractory surrounding the steel pins of the anode. These pins are the return path for the electrical flow and are typically between 1 in to 2 in in diameter. Dry vibratable monolithic refractory material is placed in the anode to surround and protect the steel pins.

However, in many situations, the steel pins and the surrounding dry vibratable monolithic refractory material are the weak links in the construction of the furnace. For example, while the dry vibratable monolithic refractory material is expected to protect the steel pins to enable the furnace to operate up to 1500 heats, i.e., cycles, without requiring the anode to be changed, the dry vibratable monolithic refractory material is also highly susceptible to failure. Such failure could result in completion of as little as 300 heats before requiring anode replacement. As such, the current lining configurations and practices are not certain to allow the anode to reach peak life expectancy.

The invention is designed to address these issues.

### SUMMARY OF THE INVENTION

In an example embodiment of the invention, an anode for a direct current electric arc furnace includes dry vibratable monolithic refractory material positioned on a bottom wall of the furnace, a plurality of steel pins extending upward from the bottom wall of the furnace and through the dry vibratable monolithic refractory material, and an anode cap positioned on top of the dry vibratable monolithic refractory material. The steel pins are surrounded by the dry vibratable monolithic refractory material. The anode cap includes a plurality of pin holes formed therein with which the steel pins correspond and through which the steel pins extend.

The present invention provides an anode for a direct current electric arc furnace in which an anode cap positioned on top of the dry vibratable monolithic refractory material serves to protect the dry vibratable from thermal shock damage at the start-up of the furnace and extend the life of the dry vibratable monolithic refractory material.

The present invention provides an anode for a direct current electric arc furnace in which an anode cap positioned on top of the dry vibratable monolithic refractory material serves to allow a hot face surface of the dry vibratable to create a more uniform and predictably generated protective sintered zone below the anode cap. The consequentially generated protective layer on the surface of the dry vibratable protects the un-sintered material from floating through the denser liquid metal bath positioned above.

The present invention further provides an anode for a direct current electric arc furnace in which an anode cap positioned on top of the dry vibratable monolithic refractory material serves to enable a more predictable and lengthier lifespan of the anode in which it is included.

These and other advantages will become apparent from the following description of a preferred embodiment taken together with the accompanying drawings and claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a top view illustrating an example of a bottom portion of an electric arc furnace including an anode according to an embodiment of the invention;

FIG. 2 is a cross-sectional view 2-2 of FIG. 1 illustrating an example of the bottom portion of the electric arc furnace including the anode according to an embodiment of the invention;

FIG. 3 is a top view illustrating an example of the anode according to an embodiment of the invention;

FIG. 4 is a cross-sectional view 4-4 of FIG. 3 illustrating an example of the anode according to an embodiment of the invention;

FIG. 5 is an enlarged sectional view 5 of FIG. 3 illustrating an example of the anode according to an embodiment of the invention;

FIG. 6 is a top view illustrating an example of the anode cap of the anode according to an embodiment of the invention;

FIG. 7 is a cross-sectional view 7-7 of FIG. 6 illustrating an example of the anode cap of the anode according to an embodiment of the invention; and

FIG. 8 is an enlarged sectional view 8 of FIG. 6 illustrating an example of the anode cap of the anode according to an embodiment of the invention.

### DETAILED DESCRIPTION OF THE INVENTION

Referring now to the drawings, wherein the showing is for illustrating a preferred embodiment of the invention only and not for limiting same, various embodiments of the invention will be described.

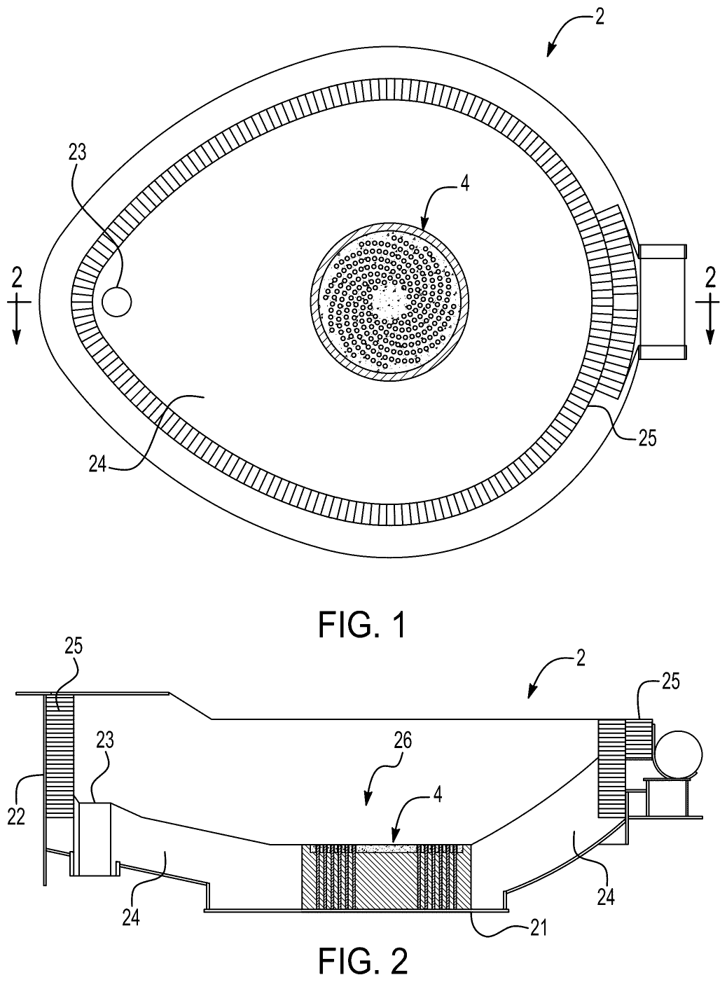

An example of a bottom portion of an electric arc furnace 2 is illustrated in FIGS. 1 and 2. The bottom portion of the furnace 2 is generally defined by a shell formed of a bottom wall 21 of the furnace 2 and a side wall 22 of the furnace 2 encircling and extending away from the bottom wall 21 of the furnace 2. The bottom wall 21 may be metal, refractory material, or some other material known to those having ordinary skill in the art to be appropriate material to constitute a bottom wall of a furnace.

A side refractory lining 25 is formed on an inner surface of the side wall 22 of the furnace 2. A bottom refractory lining 24 is formed on an inner surface of the bottom wall 21 of the furnace 2. The side refractory lining 25 and the bottom refractory lining 24 respectively protects the side wall 22 of the furnace 2 and the bottom wall 21 of the furnace 2 from material charged to and melted in a bath 26 of the furnace 2.

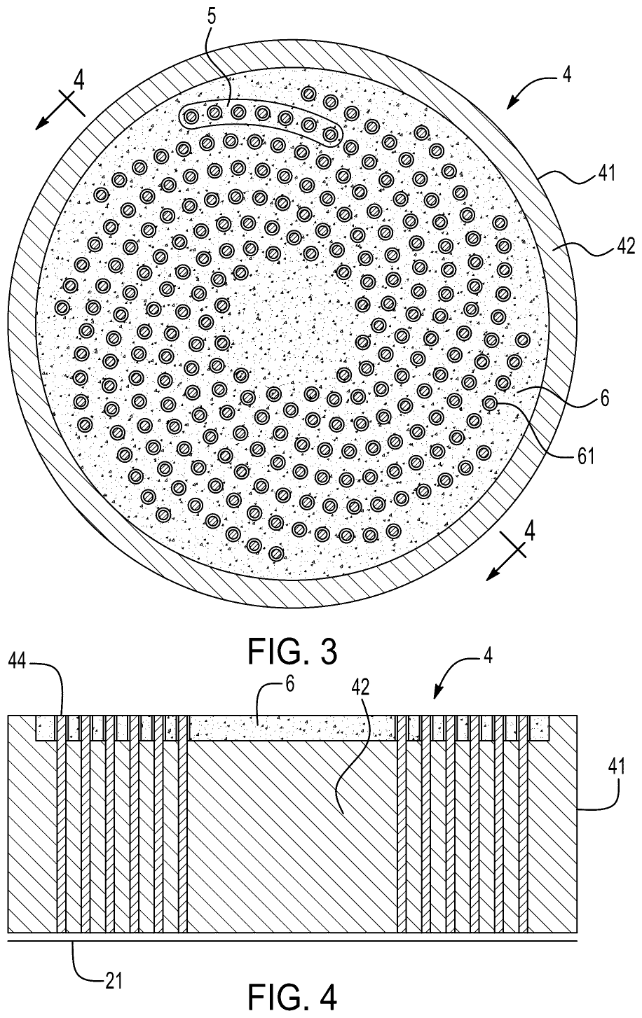

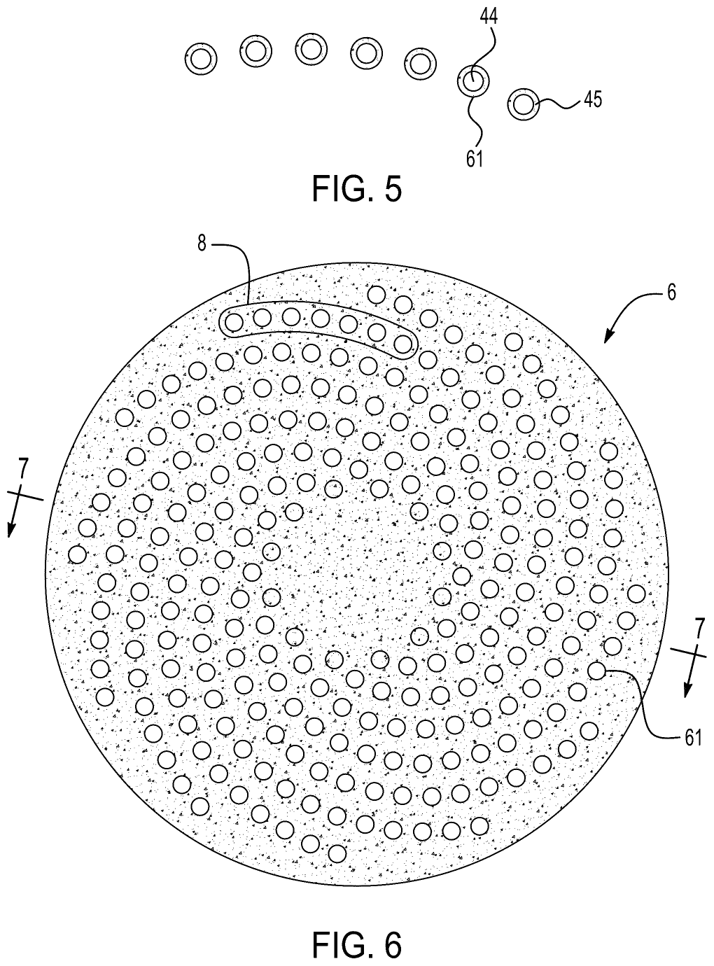

An example of a direct current anode 4 according to an embodiment of the invention is illustrated in FIGS. 3-5. The anode 4 is surrounded by the bottom refractory lining 24 and is positioned to be in direct contact with the material charged to the bath 26 for melting. As will be described further below, the melting is initiated and propagated by the arc generated between steel pins 44 of the anode 4 and the graphite cathode (not shown) positioned above it.

In this example, the footprint of the anode 4 is defined by the bottom wall 21 of the furnace 2 and a metal sidewall 41 that surrounds and extends upwards from the bottom wall 21 of the furnace 2. However, embodiments disclosed herein are not limited thereto, as there are multiple possible variations on the footprint of the anode 4 within the furnace 2. For example, a sidewall of the anode 4 may be formed by the bottom refractory lining 24. Further, the bottom wall 21 of the furnace 2 may not be involved in establishing the footprint of the anode 4. For example, the anode 4 may be positioned on a surface within the furnace 2 that is not associated with a bottom wall 21 of the furnace 2 or the bottom of the furnace 2 in any capacity.

Dry vibratable monolithic refractory material 42 is positioned on the bottom wall 21 of the furnace 2 or, in the alternative, a surface designated to be part of the footprint of the anode 4. In this example, the dry vibratable monolithic refractory material 42 is dumped and densified by mechanical vibration on top of the bottom wall 21 of the furnace. While the dry vibratable monolithic refractory material 42 may be magnesia, burned dolomite, lime, or various blends thereof, embodiments disclosed herein are not limited thereto. Multiple steel pins 44 extend upward from the bottom wall 21 of the furnace 2. The steel pins 44 are surrounded by and extend through the dry vibratable monolithic refractory material 42. The steel pins 44 are connected to an auxiliary source of electric current. The dry vibratable monolithic refractory material 42 is vibrated into place utilizing various vibration tools, thereby serving to densify the dry vibratable monolithic refractory material 42 within the anode 4 and surrounding the steel pins 44.

A cathode (not shown) is located opposite of the anode 4 in a roof (not shown) of the furnace 2. The cathode is typically a one-piece graphite electrode, but embodiments disclosed herein are not limited thereto. In addition, in the illustrated example, the furnace 2 has an eccentric bottom taphole 23, which is formed vertically or at an angle through the bottom refractory lining 24 and the bottom wall 21 of the furnace 2. The cathode is in the proximity with the steel pins 44 of the anode 4, thereby creating an arc between the anode 4 and the cathode. The arc between the anode 4 and cathode is the energy source that melts the material charged to the furnace, thereby serving to create the bath 26. An amount and a level of material in the bath 26 is determined by an amount of starting material placed in the furnace 2 for melting and any subsequent additions. In any case, the level of the bath 26 is always below the top entry of the eccentric bottom taphole 23. The furnace 2 is tapped by tilting, thereby allowing the furnace 2 to pass the molten material from the bath 26 through the taphole 23 into another vessel.

Further, the anode 4 according to an embodiment of the invention includes an anode cap 6, an example of which is generally illustrated in FIGS. 3-5 and more specifically illustrated in FIGS. 6-8. The anode cap 6 is placed on top of the dry monolithic refractory material 42 after it has been vibrated.

The anode cap 6 is designed with multiple pin holes 61 formed therein that correspond with the steel pins 44 of the anode 4. The steel pins 44 extend through the pin holes 61 and are located opposite to the cathode of the furnace 2. To enable the steel pins 44 to extend through the pin holes 61, the pin holes 61 may have diameters that are respectively greater than diameters of the steel pins 44. For example, for a pin 44 with a 1¾″ diameter, a pin hole 61 may have a diameter in a range from 2⅜″ to 2⅝″, based on the clearance needed by the pin 44. This would represent a minimum gap between the pin 44 and the pin hole 61 of ⅜″. However, embodiments disclosed herein are not limited thereto.

The area between the pin 44 and the pinhole 61 may be backfilled with dry vibratable monolithic refractory backfill material 45 on top of the dry vibratable monolithic refractory material 42. Similar to the dry vibratable monolithic refractory material 42, while the dry vibratable monolithic refractory backfill material 45 may be magnesia, burned dolomite, lime, or various blends thereof, embodiments disclosed herein are not limited thereto. Also similarly to the dry vibratable monolithic refractory material 42, the vibratable monolithic refractory backfill material 45 is vibrated into place utilizing various vibration tools, thereby serving to densify the dry vibratable monolithic refractory backfill material 45 within the anode 4 and surrounding the steel pins 44.

The anode cap 6 may be produced or constructed from any refractory composition having a use limit of 3000° F. or greater to provide protection against the molten material. For example, the anode cap 6 may be made from high conductive refractory materials. A refractory castable with stainless steel fibers may also be suitable for construction of the anode cap 6. Refractory materials containing carbon may also be used also an option for introduction of thermally conductive conditions, which may enable faster and deeper sintering of the dry vibratable monolithic refractory material backfill 45 and deliver improved corrosion resistance. Other options for the refractory composition are high purity alumina castables, 80% or 70% alumina castables, or basic castables. Moreover, the refractory composition can be based on various purities of magnesia. The refractory composition may also include stainless steel fibers or carbon, and may be assembly and drilled from a Magnesia-Carbon brick.

The anode cap 6 is illustrated in FIGS. 3-8 as a precast shape that formed and placed on top of the dry vibratable monolithic refractory material 42 in the anode 4. However, embodiments are not limited thereto. For example, alternative, the anode cap 6 could be cast in place. The steel pins 44 and the dry vibratable monolithic refractory material 42 would be generally positioned as indicated in the drawings. The material being cast in place as the anode cap 6 may be water based. In such as case, an impermeable layer, such as an aluminum or a high temperature resistant foil or barrier, would be placed on top of the dry vibratable monolithic refractory material 42 after vibration thereof. The material being cast in place as the anode cap 6 may also be non-water based, such as a resin bonded monolithic, in which case no impermeable layer would need to be placed between the dry vibratable monolithic refractory material 42 and the anode cap 6. In either case, the material being cast in place as the anode cap 6 would be poured onto the dry vibratable monolithic refractory material 42 and cured or dried out.

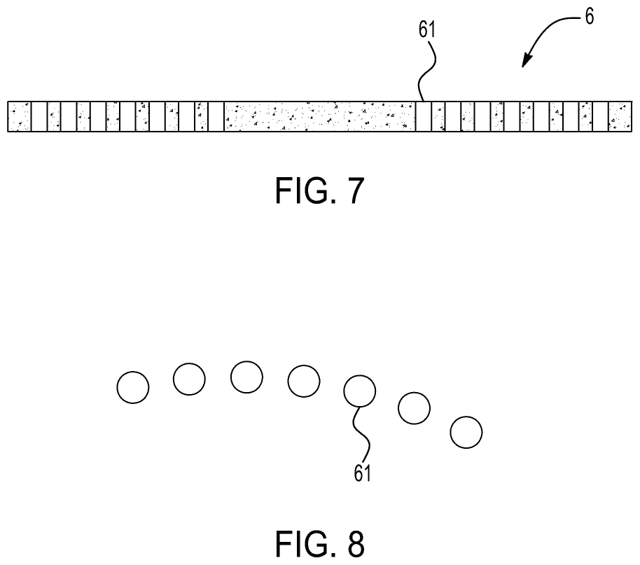

It is noted that, while FIG. 4 is a cross-sectional view 4-4 of FIG. 3 illustrating an example of the anode 4, and FIG. 7 is a cross-sectional view 7-7 of FIG. 6 illustrating an example of the anode cap 6 of the anode 4, the steel pins 44 and the pin holes 61 illustrated in FIGS. 4 and 7 respectively do not specifically correspond with the steel pins 44 and the pin holes 61 illustrated in FIGS. 3 and 6. Further, the orientation of the steel pins 44 and the pin holes 61 as illustrated in FIGS. 3-8 are not intended to limit the scope of the invention. FIGS. 3-8 are simply example illustrations that portray example orientation, positioning, and construction of the steel pins 44, the anode cap 6, and the pin holes 61.

The foregoing descriptions regard specific embodiments of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. An anode for a direct current electric arc furnace, the anode comprising:
dry vibratable monolithic refractory material positioned on a bottom wall of the furnace;
a plurality of steel pins extending upward from the bottom wall of the furnace and through the dry vibratable monolithic refractory material, the steel pins being surrounded by the dry vibratable monolithic refractory material; and
an anode cap positioned on top of the dry vibratable monolithic refractory material, the anode cap comprising a plurality of pin holes formed therein with which the steel pins correspond and through which the steel pins extend.

2. The anode according to claim 1, wherein each of the pin holes has a diameter that is greater than a diameter of a corresponding one of the steel pins.

3. The anode according to claim 2, wherein an area between the diameter of each of the pin holes and the diameter of the corresponding one of the steel pins is backfilled with dry vibratable monolithic refractory backfill material on top of the dry vibratable monolithic refractory material.

4. The anode according to claim 3, wherein the dry vibratable monolithic refractory backfill material is composed of one or more refractory materials from the group consisting of magnesia, burned dolomite, and lime.

5. The anode according to claim 1, wherein the dry vibratable monolithic refractory material is composed of one or more refractory materials from the group consisting of magnesia, burned dolomite, and lime.

6. The anode according to claim 1, wherein the anode cap is composed of refractory having a use limit greater than or equal to 3000° F.

7. The anode according to claim 1, wherein the anode cap is composed of a refractory castable with stainless steel fibers.

8. The anode according to claim 1, wherein the anode cap is composed of a refractory castables with carbon.

9. The anode according to claim 1, wherein the anode cap is composed of one or more refractory materials from the group consisting of high purity alumina castables, 80% or 70% alumina castables, magnesia based castables, castables including stainless steel fibers, castables including carbon, and magnesia-carbon brick.

10. The anode according to claim 1, wherein the anode cap is preformed.

11. The anode according to claim 1, wherein the anode cap is cast in place on the top of the dry vibratable monolithic refractory material.
